(19) United States
(12) Patent Application Publication
(10) Pub. No.: US 2026/0119228 A1
(43) Pub. Date: Apr. 30, 2026

(54) DYNAMIC BUSINESS LOGIC DISTRIBUTION

(71) Applicant: Dell Products L.P., Round Rock, TX (US)

(72) Inventors: Daniel T. DAUGHERTY, Plano, TX (US); Ricardo Antonio RUIZ, The Colony, TX (US)

(73) Assignee: Dell Products L.P., Round Rock, TX (US)

(21) Appl. No.: 18/929,821

(22) Filed: Oct. 29, 2024

(51) Int. Cl. G06F 9/48

(52) U.S. Cl. CPC G06F 9/485

(57) ABSTRACT

Disclosed method and systems that support dynamic business logic distribution features may be implemented within a software ecosystem that includes first and second processes, where, in at least some contexts, the first process may be referred to as the parent process and the second process may be referred to as the child process. The parent process may detect a request for common business logic (CBL) from the child process. The CBL may include executable code stored in a process memory of an information handling system associated with the parent process. The parent process may access and retrieve or otherwise obtain the CBL and transmit the CBL to the child process. In at least some embodiments, the child process includes a logic retriever configured to generate an exact or substantially exact replicate of the CBL, and store the replicate CBL in a process memory of an information handling system associated with the child process. The process memory of the information handling system associated with the child process may include a dynamic random access memory (DRAM) system memory or another type of volatile memory wherein the CBL does not persist in the information handling system associated with the child process beyond a power tenure of the information handling system.

### TECHNICAL FIELD

The present disclosure pertains to software ecosystems and, more particular, multi-process peer-to-peer ecosystems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

A software ecosystem may include multiple processes with each process having its own independent purpose and state, including any applicable settings, execution instructions, memory, etc. Generally, processes can communicate with each other to exchange information or features via public application program interfaces (APIs). An application policy interpreter is an example of a common public API implementation. An application policy interpreter may include single-instance business logic that understands how to parse common policy files and interfaces to provide instructions to the processes requiring policy.

Common public API ecosystems may be configured for use in peer-to-peer environments in which one process within the ecosystem may host and expose the common API implementation while calling processes may access the exposed API to receive process-specific results. The API implementation could make runtime decisions on exactly which code to execute for the specific caller, thereby insulating the calling process from much of the complexity of the applicable solution and functionality. Software models of this type are prevalent with native or system APIs, web APIs, and even pre-installed original equipment manufacturer (OEM) software for providing real-time system analysis and facilitating automatic updates for OEM systems, and collecting diagnostic information pertaining to any system issues that may arrive.

In the described ecosystem, a calling process, sometimes referred to simply as the caller, can invoke an API that belongs to another process, the called process, sometimes referred to simply as the callee, and the called process may return a result to the calling process. This paradigm works well when parameter objects passed from caller to callee, and the resulting objects passed from callee to caller, are serializable. For purposes of this description, an object is serializable when the object can be represented as a series of bytes that preserves or persists the state of the object in a transmittable form. In contrast, however, when an API requires non-serializable data or requires execution of at least some portion of the common business logic (CBL) by the second/child process, conventional approaches may experience exceptions and/or negative performance impacts.

### SUMMARY

Disclosed dynamic business logic features may employ a pair of processes including a first process, referred to herein as the parent process, which is the caretaker for the CBL, and a second process, referred to herein as the child process, that needs to execute an API contained within the CBL. The CBL may be implemented as executable code that would normally be exposed via a remote procedure call from the child process and executed by the parent process. In at least some scenarios however, it may not be feasible or possible to execute CBL code in the parent process. In accordance with disclosed subject matter, the “child process” may ask the parent process for the CBL via executable code referred to herein as the logic retriever, that executes within the child process execution space. The logic retriever is configured to find and bring executable code into the child process. The parent process may include a complementary code for function called the “logic provider”. The “parent process” will use the “logic provider” to read the compiled machine-readable code from its process memory and transmit it to the logic retriever executing in the child process. In this example the compiled machine-readable code is the CBL. In at least some embodiments, the logic retriever in the “child process” will access the CBL transmitted from the logic provider and produce an exact replica in the execution space, i.e., dynamic random access memory (DRAM) or other form of volatile system memory, of the child process. When the system is subsequently rebooted or when the “child process” terminates, the retrieval process described herein will have to be repeated.

In at least some embodiments, the “child process” uses an API interface to access the methods within the CBL. This API interface allows the child process to compile the replicated business logic. Thus, it is the CBL feature that is responsible for maintaining compatibility with the API interface. The retriever-provider paradigm may be extended to support different versions or implementations of the CBL within the same parent process. In these implementations, the “parent process” could decide at runtime which specific implementation of the business logic to send to the “child process” based on characteristics of the target. (FIG. 2) The above statement could further be expanded upon to simplify upgrades of software in the field. When a shared assembly or component is upgraded, all processes who access that component must be shut down before the upgrade can proceed. If the processes are not shut down the operating system must be rebooted. Since only one process, the “parent process” is accessing the assembly, it is the only process that must be restarted upon an upgrade. All other “child processes” may choose when they want to upgrade. For example, upon the restart of the child process they may retrieve the updated version of the CBL.

In one aspect, methods and systems that support dynamic business logic distribution features disclosed herein may be implemented within a peer to peer software ecosystem that includes first and second processes, where, in at least some contexts, the first process may be referred to as the parent process and the second process may be referred to as the child process. The parent process may detect a request for CBL from the child process. The CBL may include executable code stored in a process memory of an information handling system associated with the parent process.

The parent process may access and retrieve or otherwise obtain the CBL and transmit the CBL to the child process. In at least some embodiments, the child process includes a logic retriever configured to generate an exact or substantially exact replicate of the CBL, and store the replicate CBL in a process memory of an information handling system associated with the child process. The process memory of the information handling system associated with the child process may include a DRAM system memory or another type of volatile memory wherein the CBL does not persist in the information handling system associated with the child process beyond a power tenure of the information handling system.

The CBL may correspond to an implementation of a common feature hosted by the parent process and the child process may be configured to invoke a common feature API interface to access and execute one or more methods included within the CBL. This common feature API may be suitable for use cases that include or require non-serializable data and/or execution of some or all of the CBL by the child process.

The CBL may comprise one of two or more supported CBL versions and, in such cases, the method may further include determining, by the first/parent process at run time, which of the plurality of supported CBL versions to transmit to the second/child process. If the common feature is upgraded, each of one or more existing instances of the child process may be persisted until a predetermined event such as a reset or a power tenure transition.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates parent and child processes of a software ecosystem in accordance with disclosed features for dynamic distribution of common business logic;

FIG. 2 illustrates a representative execution flow and interaction between parent and processes;

FIG. 3 illustrates a software ecosystem including support for maintaining multiple versions of common business logic;

FIG. 4 illustrates a representative execution flow and interaction between parent and child processes of FIG. 3;

FIGS. 5-7 illustrate the software ecosystem at three stages in a CBL update process in accordance with disclosed subject matter; and

FIG. 8 illustrates an exemplary information handling system suitable for use in conjunction with systems and methods depicted in FIGS. 1-7.

### DETAILED DESCRIPTION

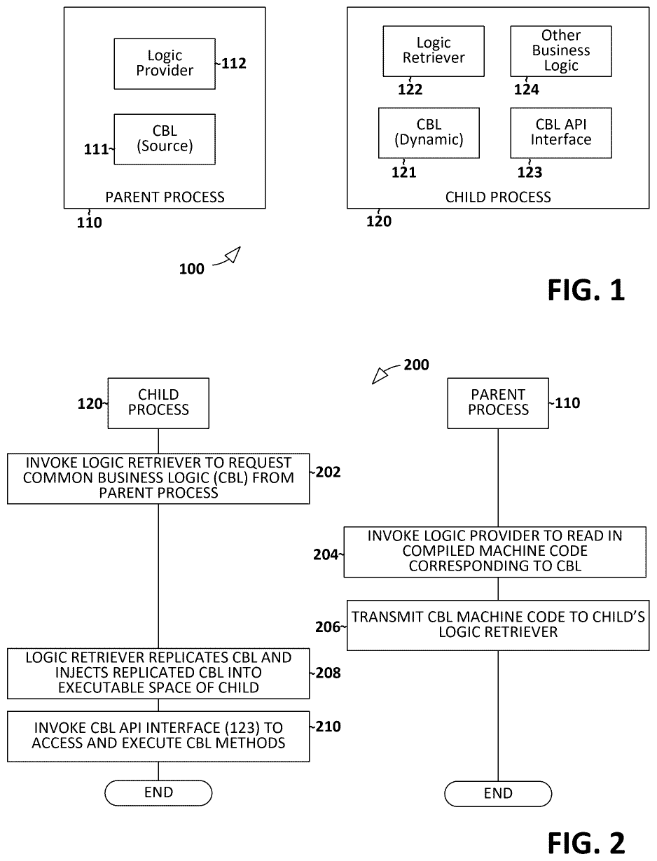

Exemplary embodiments and their advantages are best understood by reference to FIGS. 1-8, wherein like numbers are used to indicate like and corresponding parts unless expressly indicated otherwise.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”), microcontroller, or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

Additionally, an information handling system may include firmware for controlling and/or communicating with, for example, hard drives, network circuitry, memory devices, I/O devices, and other peripheral devices. For example, the hypervisor and/or other components may comprise firmware. As used in this disclosure, firmware includes software embedded in an information handling system component used to perform predefined tasks. Firmware is commonly stored in non-volatile memory, or memory that does not lose stored data upon the loss of power. In certain embodiments, firmware associated with an information handling system component is stored in non volatile memory that is accessible to one or more information handling system components. In the same or alternative embodiments, firmware associated with an information handling system component is stored in non-volatile memory that is dedicated to and comprises part of that component.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSs), buses, memories, I/O devices and/or interfaces, storage resources, network interfaces, motherboards, and/or any other components and/or elements of an information handling system.

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the un-hyphenated form of the reference numeral refers to the element generically. Thus, for example, “device 12-1” refers to an instance of a device class, which may be referred to collectively as “devices 12” and any one of which may be referred to generically as “a device 12”.

As used herein, when two or more elements are referred to as “coupled” to one another, such term indicates that such two or more elements are in electronic communication, mechanical communication, including thermal and fluidic communication, thermal, communication or mechanical communication, as applicable, whether connected indirectly or directly, with or without intervening elements.

Referring now to the drawings, FIG. 1 illustrates a representative software ecosystem 100 including components suitable for implementing disclosed features for dynamic distribution of common business logic (CBL). The software ecosystem 100 of FIG. 1 includes a parent process 110 and one or more child processes. For the sake of clarity, FIG. 1 illustrates just one child process 120, but those of ordinary skill in the field of distributed computing will readily appreciate that other implementations may include two or more child processes.

The parent process 110 depicted in FIG. 1 includes source CBL 111 and a utility identified as logic provider 112. In at least one embodiment, source CBL 111 includes executable code for implementing one or more methods, functions, etc. in accordance with an entity's business logic software or, more simply, business logic. Business logic may refer to or include software that determines the manner in which one or more applications associated with an entity interact with databases and user interfaces.

Generally, business logic implements methods, functions, and services that are used by multiple applications. Historically, business logic functionality has been deployed in a peer to peer manner in which a parent process would host the sole instance of the business logic and execute the business logic in response to API calls from one or more calling processes. The software ecosystem 100 of FIG. 1 implements dynamically distributed business logic to extend CBL solutions to encompass complex business logic including, as illustrative examples, business logic that operates on non-serializable data and/or executes within the child process.

The child process 120 illustrated in FIG. 1 includes a dynamically distributed version of CBL, referred to as dynamic CBL 121, a logic retriever 122, a CBL API interface 123, and other business logic 124. Additional detail pertaining to one or more components of child process 120 are described in more detail below.

FIG. 2 illustrates a sequence diagram for a representative execution flow 200 in accordance with disclosed dynamic business logic distribution features. The execution flow 200 depicted in FIG. 2 begins with child process 120 invoking (operation 202) its logic retriever (122) to request the CBL from parent process 110. The logic provider (112) of parent process 110 responds by reading in (operation 204) compiled machine-readable code that makes up the CBL. The logic provider 112 may then transmit (operation 206) the machine readable code corresponding to the CBL to logic retriever 122 within child process 120. Logic retriever 122 may then replicate the CBL code and inject (operation 208) the replicated code into system memory or other executable space of child process 120. Because the executable space of child process 120 generally corresponds to volatile memory, e.g., DRAM, the replicated CBL may not persist in child process 120 through a power transition. Any business logic, represented in FIG. 2 by other business logic 124, that is dependent upon CBL code is now able to execute and use CBL functionality and child process 120 may now use CBL API interface 123 to execute (operation 210) the replicated CBL.

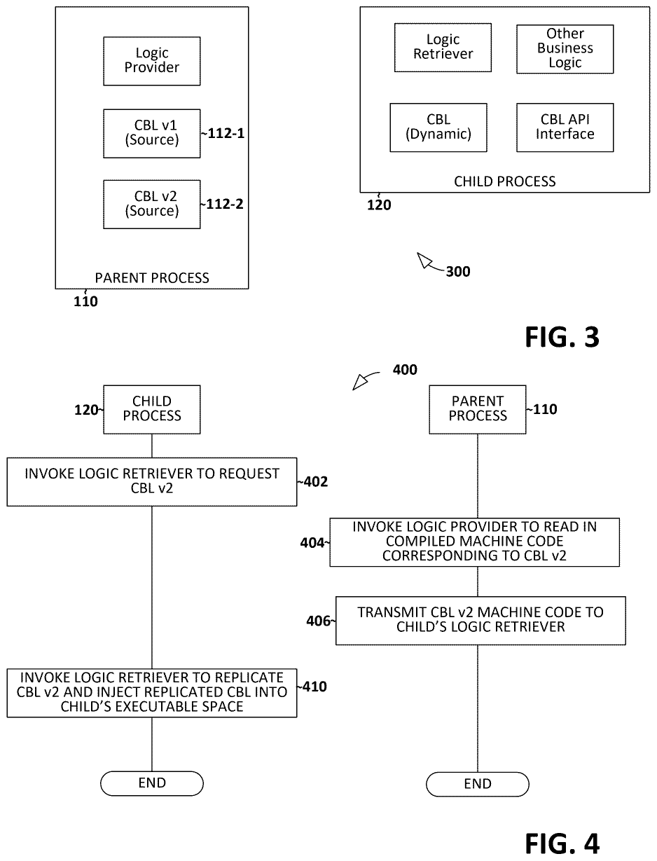

FIG. 3 illustrates a version support feature 300 of software ecosystem 100 that enables parent process 110 to support different versions or implementations of CBL 111. Thus, the parent process 110 depicted in FIG. 3 includes a first version of source CBL (CBLv1) 111-1 and a second version of source CBL (CBLv2) 111-2. In this configuration parent process 110 could decide at runtime which CBL version or implementation to send to child process 120. In at least some embodiments, parent process 110 may select the CBL version to send to child process 120 based on one or more characteristics of the child process 120. In other embodiments, child process 120 may specify a version of CBL 111 in its request to parent process 110 and parent process 110 may grant the request and send the requested version of CBL 111, deny the request and send a different version of CBL 111, e.g., deny a request for an upgraded version of CBL 111 and send a known good version instead, or deny the request and not send any CBL 111.

FIG. 4 illustrates a representative execution flow 400 corresponding to the multi-version feature described with respect to FIG. 3. As depicted in FIG. 4, child process 120 invokes (operation 402) its logic retrieve to request parent process 110 for version 2 of the CBL 111. Parent process 120 may then invoke its logic provider to read in (operation 404) source CBLv2 111-2 and transmit (operation 406) the code to child process 120. The logic receiver in child process 120 may then replicate (operation 410) CBLv2 and inject the replicated code into executable space of child process 120.

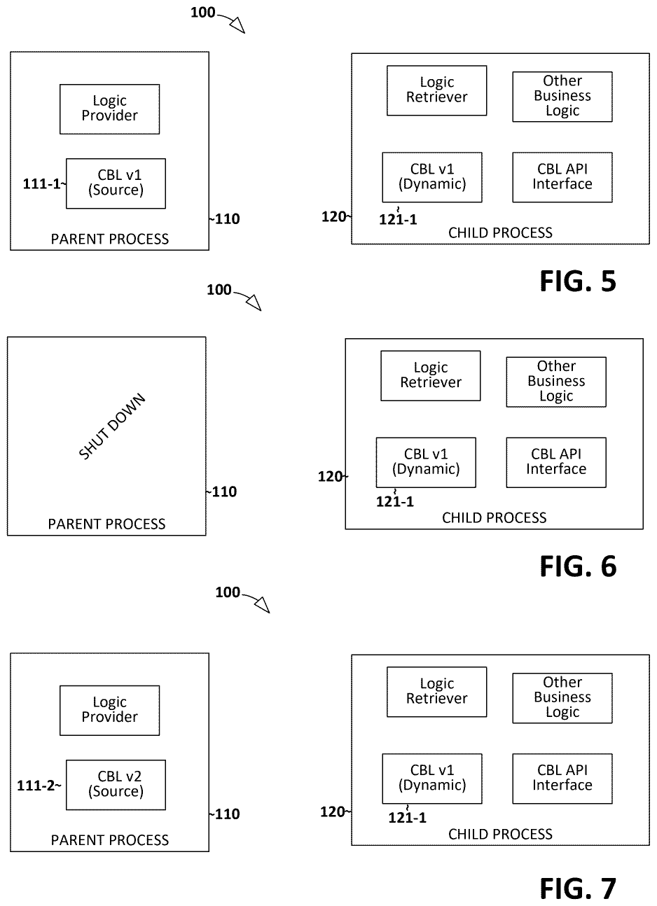

Referring now to FIGS. 5, 6, and 7, a sequence for updating source CBL 111 from source CBLv1 111-1 to source CBLv2 111-2 is depicted as a time sequence illustrating software ecosystem 100 before the CBL update (FIG. 5), during the update (FIG. 6), and following the update (FIG. 7). FIG. 5 is a snapshot of a pre-update state of software ecosystem 100, in which parent process 110 and child process 120 both include the same version of CBL code. Parent process 110 includes source CBLv1 (111-1) while child process 120 includes dynamic CBLv1 (121-1). If an upgrade of CBL is received, it is only necessary to upgrade the version or implementation on the parent process 110. The child process 120 running dynamic CBLv1 121-1 may continue to run the v1 version. Thus, FIG. 6 depicts a snapshot after parent process 110 has been shut down while child process 120 continues to run dynamic CBLv1 (121-1) and FIG. 7 depicts a snapshot after source CBL has been upgraded to source CBLv2 111-2 while child process 120 continues to run dynamic CBLv1 121-1.

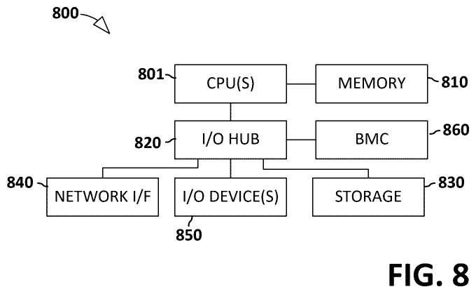

Referring now to FIG. 8, any one or more of the elements illustrated in FIG. 1 through FIG. 7 may be implemented as or within an information handling system exemplified by the information handling system 800 illustrated in FIG. 8. The illustrated information handling system includes one or more general purpose processors or central processing units (CPUs) 801 communicatively coupled to a memory resource 810 and to an input/output hub 820 to which various I/O resources and/or components are communicatively coupled. The I/O resources explicitly depicted in FIG. 8 include a network interface 840, commonly referred to as a NIC (network interface card), storage resources 830, and additional I/O devices, components, or resources 850 including as non-limiting examples, keyboards, mice, displays, printers, speakers, microphones, etc. The illustrated information handling system 800 includes a baseboard management controller (BMC) 860 providing, among other features and services, an out-of-band management resource which may be coupled to a management server (not depicted). In at least some embodiments, BMC 860 may manage information handling system 800 even when information handling system 800 is powered off or powered to a standby state. BMC 860 may include a processor, memory, an out-of-band network interface separate from and physically isolated from an in-band network interface of information handling system 800, and/or other embedded information handling resources. In certain embodiments, BMC 860 may include or may be an integral part of a remote access controller (e.g., a Dell Remote Access Controller or Integrated Dell Remote Access Controller) or a chassis management controller.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

What is claimed is:

1. A method, comprising:
detecting, by a parent process of a software ecosystem, a request, from a child process of the software ecosystem, for common business logic (CBL);
retrieving the CBL and transmitting the CBL to the child process, wherein the child process includes a logic retriever configured to generate a replicate CBL, comprising a replication of the CBL, and store the replicate CBL in a process memory of an information handling system associated with the child process.

2. The method of claim 1, wherein the CBL comprises executable code stored in a process memory of an information handling system associated with the parent process.

3. The method of claim 1, wherein the process memory of the information handling system associated with the child process comprises a volatile memory wherein the CBL does not persist in the information handling system associated with the child process beyond a power tenure of the information handling system.

4. The method of claim 1, wherein the CBL is associated with an implementation of a common feature hosted by the parent process.

5. The method of claim 4, wherein the child process is configured to invoke a common feature application program interface (API) to access and execute one or more methods included within the CBL.

6. The method of claim 5, wherein the common feature API requires use of non-serializable data.

7. The method of claim 5, wherein the common feature API requires execution of at least some of the CBL by the child process.

8. The method of claim 4, wherein the CBL comprises one of a plurality of supported CBL versions and wherein the method includes:
determining at run time, which of the plurality of supported CBL versions to transmit to the child process.

9. The method of claim 4, further comprising, responsive to detecting an upgrade of the common feature, persisting an existing instance of the child process until a predetermined event.

10. The method of claim 9, wherein the predetermined event comprises a restart of the child process.

11. An information handling system, comprising:
a central processing unit (CPU); and
a system memory, accessible to the CPU and including processor executable instructions that, when executed by the CPU, cause the system to perform operations, comprising:
detecting, by a parent process of a software ecosystem, a request, from a child process of the software ecosystem, for common business logic (CBL); and
retrieving the CBL and transmitting the CBL to the child process, wherein the child process includes a logic retriever configured to generate a replicate CBL, comprising a replication of the CBL, and store the replicate CBL in a process memory of an information handling system associated with the child process.

12. The information handling system of claim 11, wherein the CBL comprises executable code stored in a process memory of an information handling system associated with the parent process.

13. The information handling system of claim 11, wherein the process memory of the information handling system associated with the child process comprises a volatile memory wherein the CBL does not persist in the information handling system associated with the child process beyond a power tenure of the information handling system.

14. The information handling system of claim 11, wherein the CBL is associated with an implementation of a common feature hosted by the parent process.

15. The information handling system of claim 14, wherein the child process is configured to invoke a common feature application program interface (API) to access and execute one or more methods included within the CBL.

16. The information handling system of claim 15, wherein the common feature API requires use of non-serializable data.

17. The information handling system of claim 15, wherein the common feature API requires execution of at least some of the CBL by the child process.

18. The information handling system of claim 14, wherein the CBL comprises one of a plurality of supported CBL versions and wherein the method includes:
determining at run time, which of the plurality of supported CBL versions to transmit to the child process.

19. The information handling system of claim 14, further comprising, responsive to detecting an upgrade of the common feature, persisting an existing instance of the child process until a predetermined event.

20. The information handling system of claim 19, wherein the predetermined event comprises a restart of the child process.
